(19) United States
(12) Patent Application Publication
(10) Pub. No.: US 2023/0040265 A1
(43) Pub. Date: Feb. 9, 2023

(54) Shaker Bottle Device

(71) Applicant: Jana Bartley, Jacksonville, NC (US)

(72) Inventor: Jana Bartley, Jacksonville, NC (US)

(21) Appl. No.: 17/858,423

(22) Filed: Jul. 6, 2022

Related U.S. Application Data
(60) Provisional application No. 63/229,193, filed on Aug. 4, 2021.

(51) Int. Cl. B65D 23/00; B65D 43/02; B65D 23/10; B65D 47/08; B01F 33/501; B01F 33/25; B01F 35/32

(52) U.S. Cl. CPC B65D 23/006; B65D 43/0231; B65D 23/102; B65D 47/08; B01F 33/50111; B01F 33/251; B01F 35/32021; B01F 2101/14

(57) ABSTRACT

The present invention relates to a shaker bottle device that has a body and a lid. The body is further preferably comprised of at least one measuring line that indicates a corresponding amount of liquid or solid volume that is within the body, wherein the line is further highly visible using contrasting colors, fiber-optic, fluorescent, or luminescent paint. The body may also be comprised of a weighted bottom surface that prevents the device from spilling. The body and lid may also have at least one magnet that allows the device to magnetically attach to a metal surface or object to further prevent spilling.

### CROSS-REFERENCE TO RELATED APPLICATION

The present application claims priority to, and the benefit of, U.S. Provisional Application No. 63/229,193, which was filed on Aug. 4, 2021, and is incorporated herein by reference in its entirety.

### FIELD OF THE INVENTION

The present invention relates generally to the field of shaker bottles. More specifically, the present invention relates to a shaker bottle device that has a body and a lid. The body is further preferably comprised of at least one measuring line that indicates a corresponding amount of liquid or solid volume that is within the body, wherein the line is further highly visible using contrasting colors, fiber-optic, fluorescent, or luminescent paint. The body may also be comprised of a weighted bottom surface that prevents the device from spilling. The body and lid may also have at least one magnet that allows the device to magnetically attach to a metal surface or object to further prevent spilling. Accordingly, the present disclosure makes specific reference thereto. Nonetheless, it is to be appreciated that aspects of the present invention are also equally applicable to other like applications, devices and methods of manufacture.

### BACKGROUND

Many individuals use shaker bottles to consume various drinks such as protein drinks, pre-workout drinks, detox teas, coffee, etc. Said drinks normally require a specific amount of liquid and a specific amount of powder (or other solid) to be added together within the shaker bottle to create the drink, wherein the accuracy of the amount of powder and the amount of liquid added are crucial in creating the desired drink consistency. However, many shaker bottles lack any type of markings that allow a user to measure the quantity of liquid and/or powder that is poured within a shaker bottle. In addition, shaker bottles with markings are often hard to see, especially when liquid or powder is poured into the bottle. Furthermore, many individuals use shaker bottles when working out. During a workout, a shaker bottle can easily be knocked over, which can lead to the spilling of the contents of the bottle if the lid is left open.

Therefore, there exists a long-felt need in the art for an improved shaker bottle. There also exists a long-felt need in the art for a shaker bottle device that has easily identifiable indicia that allows a user to measure any liquid or powder that is poured into the device. In addition, there exists a long-felt need in the art for a shaker bottle device that cannot be easily spilled or knocked over.

The subject matter disclosed and claimed herein, in one embodiment thereof, comprises a shaker bottle device. In the preferred embodiment of the device the device has a body and a lid. The body is further preferably comprised of at least one measuring line that indicates a corresponding amount of liquid or solid volume that is within the body, wherein the line is further highly visible using contrasting colors, fiber-optic, fluorescent or luminescent paint. The body may also be comprised of a weighted bottom surface that prevents the device from spilling. The body and lid may also have at least one magnet that allows the device to magnetically attach to a metal surface or object to further prevent spilling.

In this manner, the shaker bottle device of the present invention accomplishes all of the forgoing objectives and provides an improved shaker bottle device. The device has easily identifiable indicia that allows a user to measure any liquid or powder that is poured into the device. In addition, the device cannot be easily spilled or knocked over due to the weighted bottom surface and/or the magnet that allows the device to be attached to a metal surface or object in a position wherein it cannot be easily knocked over.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shaker bottle device. In the preferred embodiment of the device the device has a body and a lid. The body and lid are preferably manufactured from a rigid plastic or durable metal material. In differing embodiments, the body and lid may be any color in the art and may be transparent, semi-transparent, or opaque. In addition, the outer surface or interior surface of the body may have indicia in the form of at least one measuring line that indicates a corresponding amount of liquid or solid volume (i.e., water, protein drink, protein/supplement powder, etc.) that is within the body. Said volume can be measured in units such as, but not limited to, ounces, liters, milliliters, fluid ounces, etc., and is preferably of a contrasting color to the body such that it can be easily seen. In one embodiment, the indicia may be made of a fiber-optic, fluorescent, or luminescent paint or material.

The body further has a first end and a second end. The first end has a flat bottom surface that may have at least one embedded weight, such that the device cannot easily be knocked over or spilled. The interior surface of the body may further be coated with an anti-stick coating such that solids such as protein/supplement powder does not stick to the interior surface while the device is being used to store and mix water, protein drink, protein/supplement powder, etc. The outer surface may also have at least one magnet, such that the body can magnetically attach to any metal surface, structure (i.e., weightlifting/gym equipment) or object.

The lid preferably has a plurality of female threads that attach to a plurality of male threads of the body, wherein the lid is further comprised of a side surface and outer surface. The outer surface may further be comprised of a spout that allows a user to drink out of the device. The lid further has a cap that can be removably attached to the spout via snapping onto the spout. The cap is further connected by at least one hinge to the outer surface of the lid. In one embodiment, the side surface may also be comprised of at least one magnet to allow the device to magnetically attach to a metal object or surface.

Accordingly, the shaker bottle device of the present invention is particularly advantageous as it has easily identifiable indicia that allows a user to measure any liquid or powder that is poured into the device. In addition, the device cannot be easily spilled or knocked over due to the weighted bottom surface and/or magnet. In this manner, the shaker bottle device overcomes the limitations of existing shaker bottles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a shaker bottle device of the present invention in accordance with the disclosed architecture;

FIG. 2 illustrates a perspective view of one potential embodiment of a shaker bottle device of the present invention in accordance with the disclosed architecture;

FIG. 3 illustrates an exploded view of one potential embodiment of a shaker bottle device of the present invention in accordance with the disclosed architecture; and

FIG. 4 illustrates a perspective view of a plurality of potential embodiments of a mixer of one potential embodiment of a shaker bottle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved shaker bottle. There also exists a long-felt need in the art for a shaker bottle device that has easily identifiable indicia that allows a user to measure any liquid or powder that is poured into the device. In addition, there exists a long-felt need in the art for a shaker bottle device that cannot be easily spilled or knocked over.

The present invention, in one exemplary embodiment, is comprised of a shaker bottle device. The device primarily has a body and a lid that is preferably manufactured from a rigid plastic or durable metal material. In differing embodiments, the body and lid may be any color in the art and may be transparent, semi-transparent or opaque. In addition, the outer surface or interior surface of the body may have indicia in the form of at least one measuring line that indicates a corresponding amount of liquid or solid volume (i.e., water, protein drink, protein/supplement powder, etc.) that is within the body. The volume can be measured in units such as, but not limited to, ounces, liters, milliliters, fluid ounces, etc., and is preferably of a contrasting color to the body, such that it can be easily seen. In one embodiment, the indicia may be made of a fiber-optic, fluorescent or luminescent paint or material.

The body further has a first end and a second end, wherein the first end has a flat bottom surface that may have at least one embedded weight, such that the device cannot easily be knocked over or spilled. The interior surface of the body may further be coated with an anti-stick coating. In this manner, solids such as protein/supplement powder do not stick to the interior surface while the device is being used to store and mix water, protein drink, protein/supplement powder, etc. The outer surface may also have at least one magnet such that the body can magnetically attach to any metal surface, structure (i.e., weightlifting/gym equipment) or object.

The lid preferably has a plurality of female threads that attach to a plurality of male threads of the body, wherein the lid is further comprised of a side surface and outer surface. The outer surface of the lid has a spout that allows a user to drink out of the device. The lid further has a cap that can be removably attached to the spout via snapping onto the spout, and wherein the cap is further connected by at least one hinge to the outer surface of the lid. In one embodiment, the side surface may also be comprised of at least one magnet to allow the device to magnetically attach to a metal object or surface.

Accordingly, the shaker bottle device of the present invention is particularly advantageous as it has easily identifiable indicia that allows a user to measure any liquid or powder that is poured into the device. In addition, the device cannot be easily spilled or knocked over due to the weighted bottom surface and/or magnet. In this manner, the shaker bottle device overcomes the limitations of existing shaker bottles known in the art.

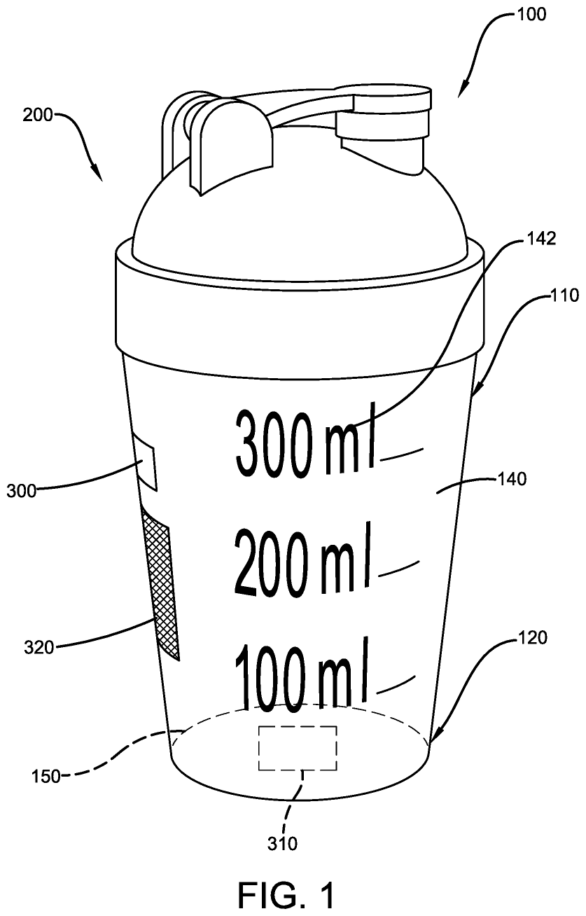

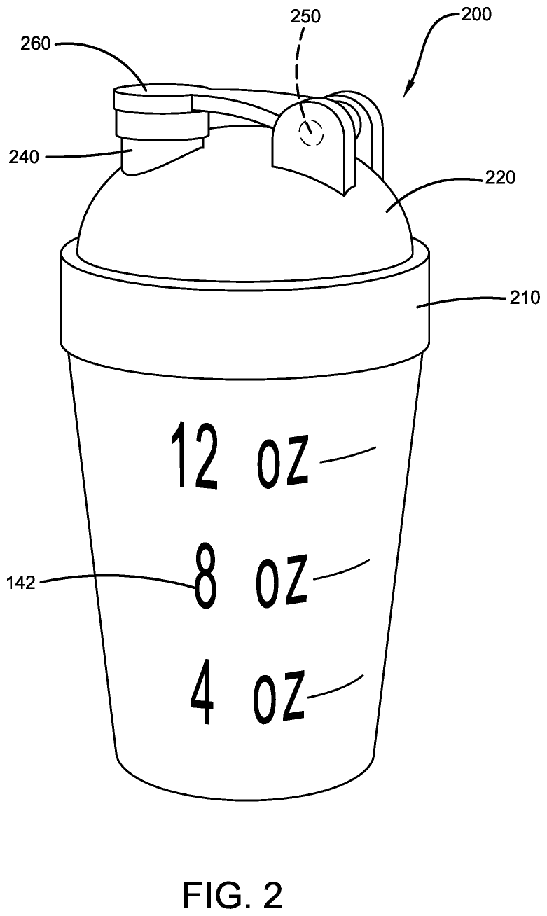

Referring initially to the drawings, FIG. 1 illustrates a perspective view of one potential embodiment of a shaker bottle device 100 of the present invention in accordance with the disclosed architecture. In the preferred embodiment, the device 100 has a body 110 and a lid 200. The body 110 and lid 200 are preferably manufactured from a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The body 110 and lid 200 may also be manufactured from a durable metal such as, but not limited to, stainless steel or aluminum, which may also be magnetic. In differing embodiments, the body 110 and lid 200 may be any color in the art and may be transparent, semi-transparent, or opaque. In addition, the outer surface 140 and/or interior surface 170 of the body 110 and the lid 200 may be comprised of a plurality of indicia 142 such as, but not limited to, patterns, logos, emblems, images, symbols, designs, letters, numbers, words, characters, animals, advertisements, brands, measuring lines, etc. In the preferred embodiment, the indicia 142 is in the form of at least one measuring line. The line indicates a corresponding amount of liquid or solid volume (i.e., water, protein drink, protein/supplement powder, etc.) that is within the body 110. Said volume can be measured in units such as, but not limited to ounces, liters, milliliters, fluid ounces, etc., as also seen in FIG. 2. Further, the indicia 142 is preferably of a contrasting color to the body 110 such that it can be easily seen. In one embodiment, the indicia 142 may be made of a fiber-optic, fluorescent, or luminescent paint or material that is applied to or embossed/engraving into the outer surface 140.

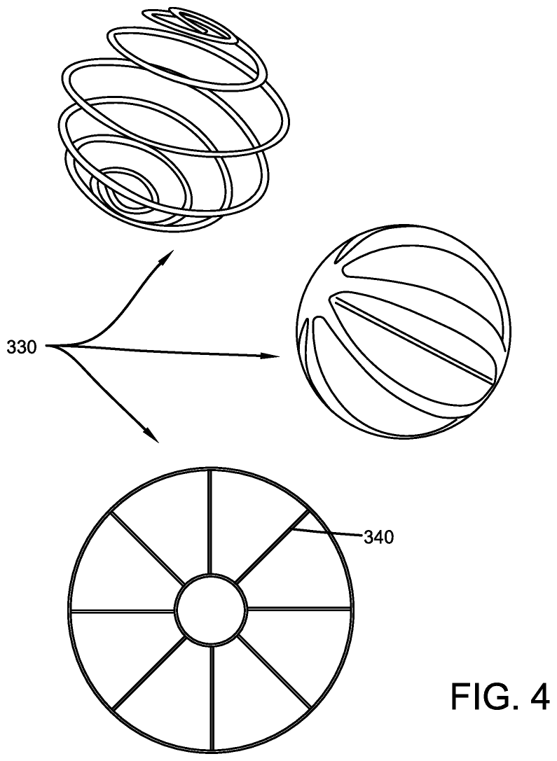

The body 110 further has a first end 120 and a second end 130. The bottom surface 150 is located at the first end 120, and is preferably flat and round, and wherein the body 110 mirrors the shape of the bottom surface 150. However, in differing embodiments the bottom surface 150 may be any shape such as, but not limited to, square, triangular, octagonal, etc. such that the shape of the body 110 facilitates mixing of the contents (i.e., water, protein drink, protein/supplement powder, etc.) within the body 110. Additionally, the device 100 may be comprised of at least one removable mixer 330. The mixer 330 may be in the form a mixer ball made of plastic or wire, or a plastic mixing ring that fits within the device 100 and has a plurality of angled members 340, as shown in FIG. 4. The mixer 330 further facilitates the mixing of the contents. The interior surface 170 of the body 110 may further be coated with an anti-stick coating such that solids such as protein/supplement powder does not stick to the interior surface 170 while the device 100 is being used to store and mix water, protein drink, protein/supplement powder, etc.

The bottom surface 150 may also have at least one embedded weight 310. In this manner, the bottom surface 150 is weighted, such that the device 100 cannot easily be knocked over or spilled. The outer surface 140 may also have at least one textured grip 320 that may be engraved into the outer surface 140 in the form of a grip texture. In a differing embodiment, the grip 320 may be a rubbered, textured grip inlay. The outer surface 140 may also have at least one magnet 300 of any magnet-type known in the art. In this manner, the body 110 can be magnetically attached to any metal surface, structure (i.e., weightlifting/gym equipment) or object.

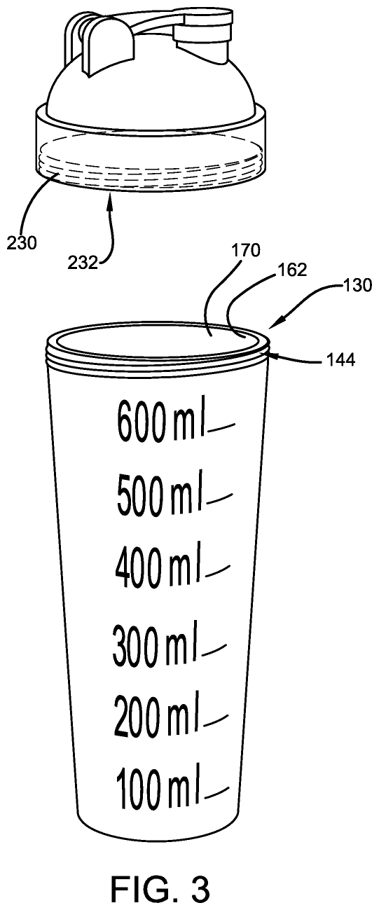

FIG. 3 illustrates an exploded view of one potential embodiment of a shaker bottle device 100 of the present invention in accordance with the disclosed architecture. The second end 130 further has a continuous opening 162. The portion of the outer surface 140 around the continuous opening 162 may further have a plurality of male threads 144 that can be threaded to a plurality of female threads 232 located on the interior surface 230 of the lid 200. However, in one embodiment the lid 200 may simply snap onto the body 110.

The lid 200 is further comprised of a side surface 210 and outer surface 220. The outer surface 220 may further be comprised of a spout 240 that allows a user to drink out of the device 100. The lid 200 further has a cap 260 that can be removably attached to the spout 240 via snapping onto the spout 240. The cap 260 is further connected by at least one hinge 250 to the outer surface 220 of the lid 200. In one embodiment, the side surface 210 may also be comprised of at least one magnet 300 to allow the device 100 to magnetically attached to a metal object or surface.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shaker bottle device” and “device” are interchangeable and refer to the shaker bottle device 100 of the present invention.

Notwithstanding the forgoing, the shaker bottle device 100 of the present invention and its various components can be of any suitable size and configuration as is known in the art without affecting the overall concept of the invention, provided that they accomplish the above-stated objectives. One of ordinary skill in the art will appreciate that the size, configuration and material of the shaker bottle device 100 as shown in the FIGS. are for illustrative purposes only, and that many other sizes and shapes of the shaker bottle device 100 are well within the scope of the present disclosure. Although the dimensions of the shaker bottle device 100 are important design parameters for user convenience, the shaker bottle device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shaker bottle device comprising:
a body comprised of a first end having a bottom surface, a second end having an opening therein, an outer surface and an interior surface;
an indicia; and
a lid comprised of a side surface, an outer surface, a spout, a cap and a hinge.

2. The shaker bottle device of claim 1, wherein the indicia is located on the outer surface of the body.

3. The shaker bottle device of claim 1, wherein the bottom surface is further comprised of a weight.

4. The shaker bottle device of claim 1, wherein the side surface of the lid is further comprised of a magnet.

5. A shaker bottle device comprising:
a magnet;
a body comprised of a first end having a bottom surface, a second end having an opening therein, an outer surface having a grip area and an interior surface;
an indicia;
a lid comprised of a side surface, an outer surface, a spout, a cap and a hinge; and
a weight positioned on the first end.

6. The shaker bottle device of claim 5, wherein the indicia is located on the outer surface of the body.

7. The shaker bottle device of claim 6, wherein the indicia is a measuring line.

8. The shaker bottle device of claim 7, wherein the indicia represents a volume.

9. The shaker bottle device of claim 8, wherein the indicia is a fiber-optic, a fluorescent or luminescent.

10. The shaker bottle device of claim 5, wherein the magnet is located on the outer surface of the body or the side surface of the lid.

11. The shaker bottle device of claim 5, wherein the body is comprised of a plurality of male threads and the lid is comprised of a plurality of corresponding female threads.

12. The shaker bottle device of claim 11, wherein the body removably attaches to the lid.

13. A shaker bottle device comprising:
a magnet;
a body comprised of a first end having a bottom surface, a second end having an opening therein, an outer surface having a grip area with a grip inlay, and an interior surface;
an indicia;
a lid comprised of a side surface, an outer surface, a spout, a cap and a hinge; and
a weight.

14. The shaker bottle device of claim 13, wherein the indicia is located on the outer surface of the body.

15. The shaker bottle device of claim 14, wherein the indicia is a measuring line.

16. The shaker bottle device of claim 15, wherein the indicia represents a volume.

17. The shaker bottle device of claim 16, wherein the indicia is a fiber-optic

18. The shaker bottle device of claim 16, wherein the indicia is fluorescent or luminescent.

19. The shaker bottle device of claim 13, wherein the magnet is located on the outer surface of the body or the side surface of the lid.

20. The shaker bottle device of claim 13, wherein the body is comprised of a plurality of male threads and the lid is comprised of a plurality of corresponding female threads.
